(19) United States
(12) Patent Application Publication
(10) Pub. No.: US 2012/0151969 A1
(43) Pub. Date: Jun. 21, 2012

(54) METHOD AND DEVICE FOR PRODUCING THIN SILICON RODS

(75) Inventors: Bruno LICHTENEGGER, Emmerting (DE); Matthaeus SCHANTZ, Reut (DE)

(73) Assignee: WACKER CHEMIE AG, Muenchen (DE)

(21) Appl. No.: 13/316,672

(22) Filed: Dec. 12, 2011

(30) Foreign Application Priority Data
Dec. 17, 2010 (DE) 10 2010 063 407.7

(51) Int. Cl. C03B 37/16; C03B 33/10; B28D 1/02; C03B 33/06

(52) U.S. Cl. 65/437; 65/514; 125/12

(57) ABSTRACT

A method for producing thin silicon rods includes: a) providing a rod of silicon; b) sequentially cutting with a sawing device slabs from the rod, wherein the rod is respectively rotated axially through 90° or 180° between two successive cuts so that two of four successive cuts respectively take place pairwise on radially opposite sides of the rod or wherein slab cutting takes place simultaneously together at radially opposite sides of the rod; and c) sawing the cut slabs into thin rods having a rectangular cross section. A device for producing thin rods from a silicon rod by sawing, contains a first unit with cutting tools and a cutting tool cooling liquid, a second unit having nozzles for introducing additional cooling liquid into cutting kerfs of the workpiece, and a third unit having a band saw, a wire saw or cutting tools containing one or more shafts.

### BACKGROUND OF THE INVENTION

The invention relates to a method and a device for producing thin silicon rods.

Thin silicon rods are used for the deposition of polycrystalline silicon.

Polycrystalline silicon (abbreviation: polysilicon) is used as a starting material for the production of monocrystalline silicon by means of crucible pulling (Czochralski or CZ method) or by means of zone melting (float zone or FZ method). This monocrystalline silicon is cut into wafers and, after a multiplicity of mechanical, chemical and chemical-mechanical processing operations, is used in the semiconductor industry to fabricate electronic components (chips).

In particular, however, polycrystalline silicon is required to an increased extent for the production of monocrystalline or polycrystalline silicon by means of pulling or casting methods, this monocrystalline or polycrystalline silicon being used to fabricate solar cells for photovoltaics.

The polycrystalline silicon, often abbreviated to polysilicon, is conventionally produced by means of the Siemens process. In this case, thin rods of silicon are heated by direct passage of current in a bell-shaped reactor (“Siemens reactor”) and a reaction gas comprising a component containing silicon and hydrogen is introduced.

As components containing silicon, for example silicon-halogen compounds such as silicon-chlorine compounds, in particular chlorosilanes, are suitable. The component containing silicon is introduced together with hydrogen into the reactor. At temperatures of more than 1000° C., silicon is deposited on the thin rods. This finally produces a rod consisting of polycrystalline silicon. DE 1 105 396 describes the basic principles of the Siemens process.

With respect to the production of thin rods, it is known from DE 1 177 119 to deposit silicon on a support body made of silicon, then to separate a part thereof and in turn use this separated part as a support body for the deposition of silicon. The separation may be carried out mechanically, for example by means of sawing, or electrolytically by means of a liquid jet. The mechanical separation is carried out in the longitudinal direction. The section planes may be placed at an angle to one another through the geometrical axis of the silicon rod. It is also proposed to cut bands or strips, which are used as supports for new deposition processes, by parallel-guided cuts that extend through the silicon rod parallel to its axis. Such parallel cuts can be accomplished simultaneously in a single working step.

US 2010/0077897 A1 discloses a device for producing thin rods, in which a silicon rod can first be separated along its axis into a multiplicity of plates or slabs, these plates or slabs subsequently being cut again in the axial direction in order to reduce their thickness. The device also provides a multiplicity of horizontally arranged saw blades, which make it possible to separate a multiplicity of these plates or slabs in one working step. Its essential aspect is to avoid bending and damage when sawing the plates, by fastening them on a table and supporting them at the end during the sawing.

It is thus known to produce thin rods by means of various sawing or cutting methods from silicon rods prepared beforehand using the Siemens process.

The process conditions for the deposition of polysilicon in the Siemens process are conventionally adjusted for economic reasons so that as high as possible a deposition rate is obtained.

In this case, polysilicon rods with a large diameter, for example more than 100 mm, are then produced. Such rods, however, have high thermal stresses which can cause problems during further mechanical processing.

With unsuitable process management in the conventional sawing and cutting methods, the rods can break. The thin rods produced can be distorted, in which case they are unsuitable for subsequent use in the Siemens process.

The methods known from the prior art for producing thin rods from polysilicon rods with a large diameter, which have significant thermal stresses, lead to a fracture taking place either in the cut workpiece or the polysilicon rod to be cut. In less dramatic cases, dislocations often occur which are likewise undesirable and are therefore to be avoided.

WO 2010/039570 A2 describes that stresses, which occur during the production of polysilicon rods in the Siemens process, can be removed again by means of heat treatment (annealing). The stresses occurring during the deposition are successfully eliminated in this way so that the rod can readily be processed further for the production of thin rods by the conventional sawing and cutting methods known from the prior art.

A disadvantage of this method, however, is that significant outlay has to be expended both in terms of energy and due to additional devices, in order to prepare the rods for the cutting of thin rods.

In addition, when annealing the rods, the risk arises that surface impurities will diffuse into the bulk of the material and thus contaminate the final product. In order to prevent this, an additional cleaning step (such as an etching step) would be necessary directly before the annealing step, but this would mean further significant additional outlay.

DE 100 19 601 B4 describes a method in which polysilicon rods, which have thermal stress, are cut transversely to the longitudinal axis in such a way that no dislocations or cracks occur. The rods are in this case rotated about their own longitudinal axis during the cutting, while a cutting tool cuts the rod to length from the outside. In this case, however, starting rods for FZ or recharge rods for CZ are produced rather than thin rods.

It was therefore the object of the invention to avoid the disadvantages described above in thin rod production due to thermal stresses in the silicon rods, without having to resort to elaborate heat treatments.

### DESCRIPTION OF THE INVENTION

The object is achieved by a method for producing thin silicon rods, comprising the following steps: a) providing a rod of silicon; b) sequentially cutting slabs having a particular thickness from the rod by means of a sawing device, wherein the rod is respectively rotated axially through 90° or 180° between two successive cuts so that of four successive cuts two of the four cuts respectively take place pairwise on radially opposite sides of the rod or wherein the cutting of the slabs takes place simultaneously together at radially opposite sides of the rod; and c) sawing the cut slabs into thin rods having a rectangular cross section.

The object is also achieved by a method for producing thin silicon rods, comprising the steps: a) providing a rod of silicon; b) producing a multiplicity of vertical cuts over a total length of the rod by means of a first sawing device, wherein the individual cuts are mutually separated, wherein the spacing of the cuts and the cutting depth are formed according to the desired edge length of a thin rod with a rectangular cross section to be produced; c) producing a horizontal cut in the longitudinal direction of the rod by means of a second sawing device, in order to separate thin rods having a rectangular cross section from the rod; wherein steps b) and c) are sequentially carried out several times in succession and the rod is respectively rotated axially through 90° or 180° between two successive cuts according to c) so that of four successive cuts according to c) two of the four cuts respectively take place pairwise on radially opposite sides of the rod.

Both methods according to the invention are suitable, in particular, for monocrystalline or polycrystalline silicon rods having a diameter of more than 100 mm.

In this case, the rods may have a significant thermal stress but can still be processed further to form thin rods by means of the two methods. Preferably, such rods are used in the method according to the invention and sent to the cutting process.

The two methods differ in that in the first method according to the invention, slabs are cut alternatingly from the rod and are subsequently sawed to form thin rods, while in the second method according to the invention mutually separated indentations are initially formed in the rod, so that the finished thin rods are already produced by the horizontal cuts which correspond to the cutting of a slab in the first method according to the invention.

### Description of the First Method According to the Invention

A rod of silicon is first to be provided. It is preferably a rod of polycrystalline silicon, as may be produced for example by deposition in the Siemens process.

Slabs of a particular thickness are sequentially cut from this rod. The thickness of these rods preferably corresponds to an edge length of a thin rod to be produced with a rectangular, preferably square cross section.

What is essential according to the invention is that the rod is respectively rotated axially through 90° or 180° between two successive cuts so that of four successive cuts two of the four cuts respectively take place pairwise on radially opposite sides of the rod, or the cutting of the slabs takes place simultaneously together at radially opposite sides of the rod.

In order finally to produce thin rods, the cut slabs are correspondingly sawed. The sawing of a slab into thin rods is preferably carried out simultaneously together in one step.

Preferably, a slab is first cut on one side of the rod. The rod is subsequently rotated through 180° about its longitudinal axis. A further slab is then cut on the radially opposite side. Finally, the rod is rotated again through 180° and the next slab is again cut at the opposite radial position.

This can be continued without problems until the last slab, without detrimental effects of the thermal stresses being perceptible. The rod may in this case remain clamped in a centered fashion at the end.

As an alternative, the rod may also be rotated according to Table 1, without experiencing stress-induced effects. The cut number and the rotation angle about the longitudinal axis are respectively represented.

TABLE 1

| Cut | Angle |
|---|---|
| 1 | 0° |
| 2 | 180° |
| 3 | 90° |
| 4 | 270° |
| 5 | 0° |

Here, after the first cut, the rod is first rotated through 180° and cut. Rotation through 90° is subsequently carried out in the opposite direction about the longitudinal axis of the rod, and then cut 3 is made. Finally, rotation through 180° is carried out, so that an angle of 270° with respect to the starting position is reached. Cut 4 is thus made at the opposite position on the rod to that of cut 3. This also applies for cuts 1 and 2.

This is preferably continued as far as the middle of the rod or until a square cross section is reached. After this, the angles 0° and 180° are alternated between.

It is therefore preferable respectively to make two successive cuts, for example cuts 1 and 2, cuts 3 and 4, cuts 5 and 6, etc., at opposite positions on the lateral surface of the rod.

Another preferred embodiment is shown by Table 2.

Here, cuts 1 and 3 and cuts 2 and 4 are made at opposite positions of the rod.

TABLE 2

| Cut | Angle |
|---|---|
| 1 | 0° |
| 2 | 90° |
| 3 | 180° |
| 4 | 270° |
| 5 | 0° |

This is preferably continued as far as the middle of the rod or until a square cross section is reached. After this, the angles 0° and 180° are alternated between.

Another more particularly preferred embodiment consists in separating the rod stress-free by means of two parallel cuts. In this case, a further slab is simultaneously cut on the opposite side. This is shown in Table 3.

TABLE 3

| Cut | Angle |
|---|---|
| 1 and 2 | 0° and 180° |
| 3 and 4 | 90° and 270° |

Here, the two cuts 1 and 2 are made parallel on opposite sides. The rod is subsequently rotated through 90°. Cuts 3 and 4 are then made, likewise on opposite sides.

This is preferably continued as far as the middle of the rod or until a square cross section is reached. After this, the angles 0° and 180° are alternated between until there is no longer any material.

Another embodiment is shown by Table 4.

Here, the parallel cuts are always made at the same positions.

TABLE 4

| Cut | Angle |
|---|---|
| 1 and 2 | 0° and 180° |

Preferably, parallel cuts are made at the angles 0° and 180° until there is no longer any material.

### Description of the Second Method According to the Invention and the Device According to the Invention

A rod of silicon is first provided. It is preferably a rod of polycrystalline silicon, produced for example by deposition in the Siemens process.

In the first step, a multiplicity of vertical cuts are produced over a total length of the rod by means of a first sawing device.

In this case, the individual cuts are mutually separated.

The spacing of the cuts is selected so that it corresponds to the desired edge length (about 5-10 mm) of the thin rod to be produced. Of course, the cutting width of the cutting tool is to be taken into account in this case.

The cutting depths of the cuts produced in the first step are also selected according to the desired edge length of a thin rod to be produced.

The thin rods to be produced have a rectangular, preferably square cross section.

Effectively, therefore, the cross sections of the thin rods to be produced are sawed in the first step.

In the next step, a horizontal cut is then made in the longitudinal direction of the rod by means of a second sawing device.

In this way, the thin rods with a rectangular cross section are finally separated from the rod.

What is essential according to the invention is that the rod is respectively rotated axially through 90° or 180° between two successive horizontal cuts so that, of four successive horizontal cuts, two of the four cuts respectively take place pairwise on radially opposite sides of the rod.

What is essential according to the invention for the device for carrying out the method is that means are provided which allow simultaneous separation of a cut slab.

The object of the invention is also achieved by a device for producing thin rods from a polycrystalline silicon rod by sawing, containing a first unit comprising a multiplicity of cutting tools and a cooling liquid for cooling the cutting tools, a second unit comprising nozzles for introducing additional cooling liquid into cutting kerfs of the workpiece to be processed, and a third unit comprising a band saw or a wire saw or cutting tools containing one or more shafts.

The device comprises three units: a first unit for parallel cutting of a plurality of vertical indentations, which extend in the longitudinal direction of the rod and whose cut depth is somewhat greater than the thickness of the cut slab; a second unit for delivering a suitable cooling liquid into the cut indentations; and a third unit for carrying out a horizontal longitudinal cut of the rod.

The first unit is preferably a shaft having saw blades.

It is likewise preferable to use a liquid-guided laser as a cutting tool.

The third unit may be a single- or double-shaft saw containing saw blades.

With such a device, the method can be carried out both with rods laid flat and with rods placed upright.

The use of the device with rods laid flat will be considered below. The invention will be explained with the aid of FIGS. 1 to 6.

### LIST OF REFERENCES USED

1 rod/workpiece
2 rod holder
3 shaft
4 saw blade
5 cooling tube
6 cooling liquid
7 tube with nozzles
8 high-pressure nozzle
9 band/wire saw

### BRIEF DESCRIPTION OF THE FIGURES

FIG. 1 shows a rod and a rod holder as well as a shaft having saw blades.

FIG. 2 shows a rod as well as a saw blade and a cooling tube.

FIG. 3 shows a rod and a rod holder as well as a tube comprising nozzles.

FIG. 4 shows a rod and a saw blade and a cooling tube as well as a tube comprising a high-pressure nozzle.

FIG. 5 shows a rod and a rod holder as well as a band or wire saw and a tube comprising nozzles.

FIG. 6 shows a rod and two saw blades and a tube comprising nozzles.

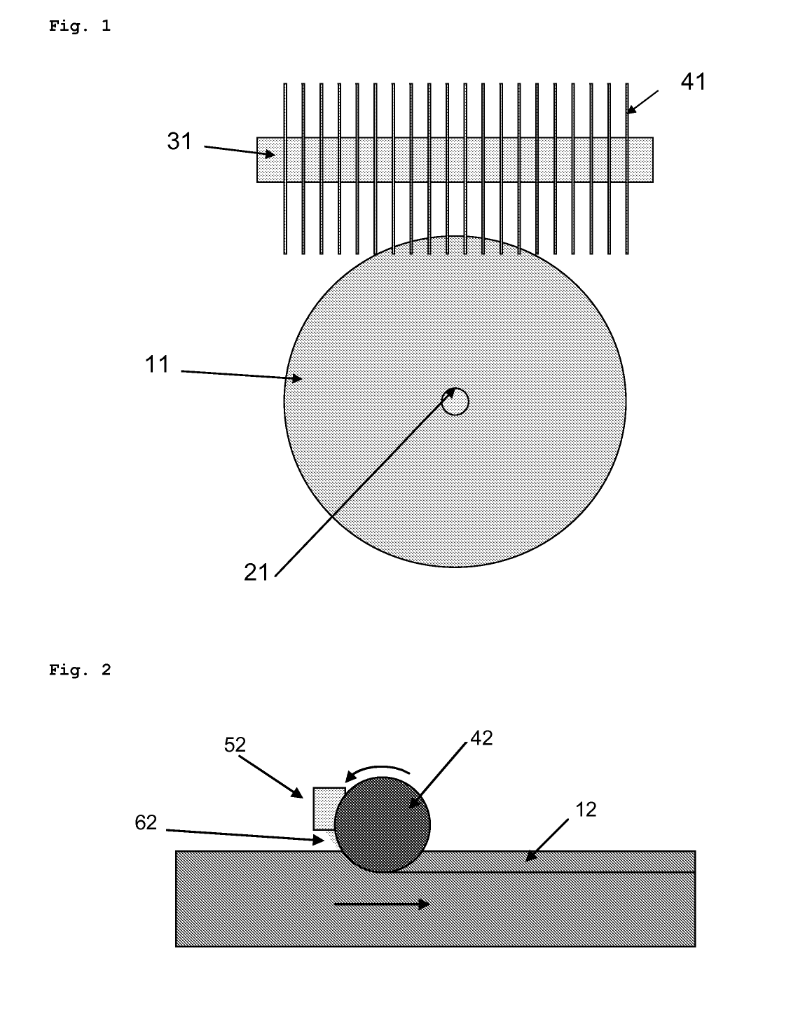

FIG. 1 shows, in particular, the shaft with the saw blades located thereon.

The first unit comprises a shaft 31 having axially offset saw blades 41, the cutting width of which preferably lies between 0.1 and 5 mm (particularly preferably from 0.2 to 0.8 mm). If a liquid-guided laser is used, the cutting width is less than 0.1 mm, for example 40-80 μm.

The desired cutting depth of this shaft 31 having saw blades 41 is preferably somewhat more than the edge length of the finished thin rod (preferred edge length 5-10 mm).

The sawing depth should be somewhat greater than the maximum desired slab thickness.

The cuts are made in the axial longitudinal direction of the rod.

The cutting process may be carried out either in the same direction or in opposite directions. Owing to the better cooling and stress properties, the same direction is particularly preferred.

The spacing of the saw blades 41 less the cutting width determines the width of the future thin rods.

During the sawing, the silicon rod 11 is, for example, fixed on the two end faces (rod holder 21).

FIG. 2 shows the arrangement which supplies the saw blades 42 with cooling liquid 62.

The saw blades 42 used are respectively supplied with a cooling liquid 62 during the cutting, so that the cooling liquid 62 can enter the sawing kerf in the running direction of the saw blade 42 in order to cool the rod 12 and simultaneously to carry away the sawing slurry being formed.

The cooling liquid 62 may in this case be supplied by means of nozzle tubes which are aimed at each saw blade, or alternatively with a wide-jet nozzle.

Another possibility for the cooling liquid supply involves a tube 52 to which cooling liquid is applied, and into which the saw blades project.

Surprisingly, such a slotted tube 52, the grooves (slots) of which are entered by the saw blades 42, has achieved the best cooling effect. In this case, it is preferable for the slotted cooling groove to be somewhat wider than the cutting blade being used. If the cutting blade has a thickness of about 8 mm, for example, the cooling groove should have a width of about 8.5 mm.

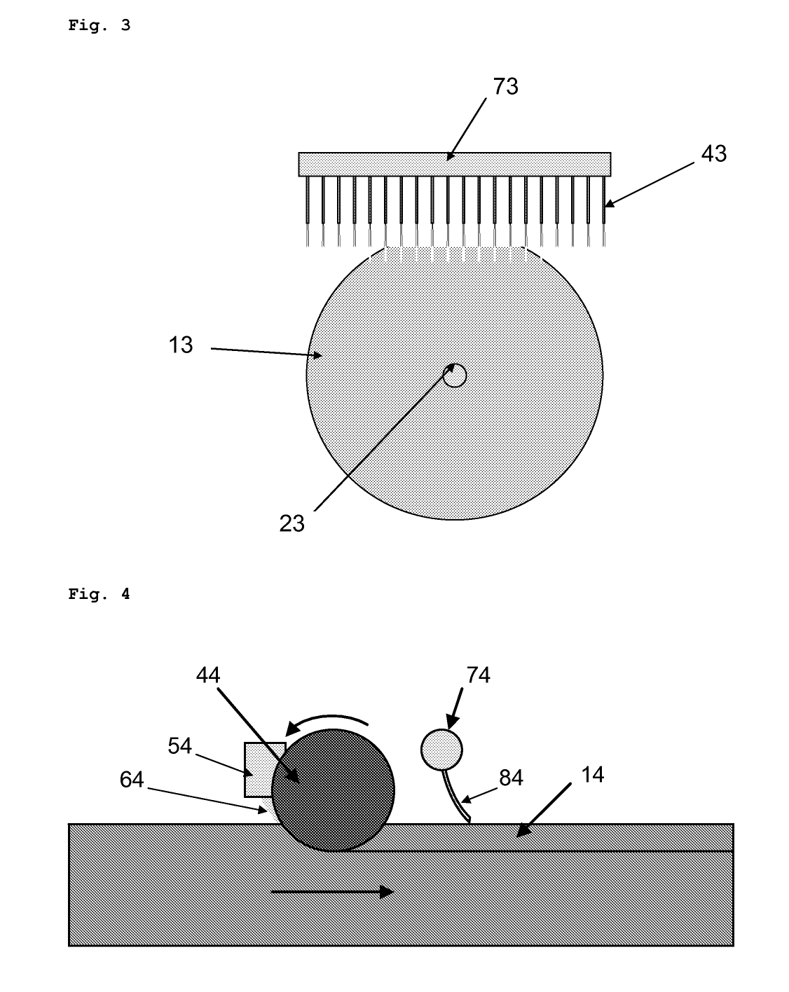

FIG. 3 shows the supply of cooling liquid by means of high-pressure nozzles in the axial direction.

The second unit, which is shown in FIG. 3, ensures that additional cooling liquid is introduced into the cutting grooves being formed.

The purpose of this additional coolant supply device is, on the one hand, further cleaning of sawing slurry being formed from the cutting grooves and, on the other hand, cooling of the rod for the horizontal cut which is made by the third unit.

In the simplest case, the second unit is configured as a tube 73, in which holes are made on one side with a spacing d so that water is transported under pressure from the tube 73 to the cutting groove.

The spacing d preferably corresponds to the spacing of the saw blades 43 of the first unit.

In order to avoid the pressure loss as a function of the tube 73, the tube 73 is preferably supplied with cooling liquid at a plurality of positions.

The flow of the cooling liquid into the grooves in this case preferably extends vertically with respect to the axis of the rod 13. Then, the washing effect is rather low.

FIG. 4 shows a high-pressure nozzle 84 on a tube 74, which projects cooling liquid into the sawing grooves at an angle of almost 90° and thus ensures optimized washing.

It has been found that the use of high-pressure nozzles 84 at each opening of the tube 74 is particularly advantageous.

These high-pressure nozzles 84 can be bent through up to 90° so that the flow of the cooling liquid can be introduced in parallel to the longitudinal axis of the rod 14. Then, the washing of the sawing slurry is thereby optimized without impairing the cooling effect.

The tube 74 is supplied with liquid from above (not shown) by means of a plurality of supply lines.

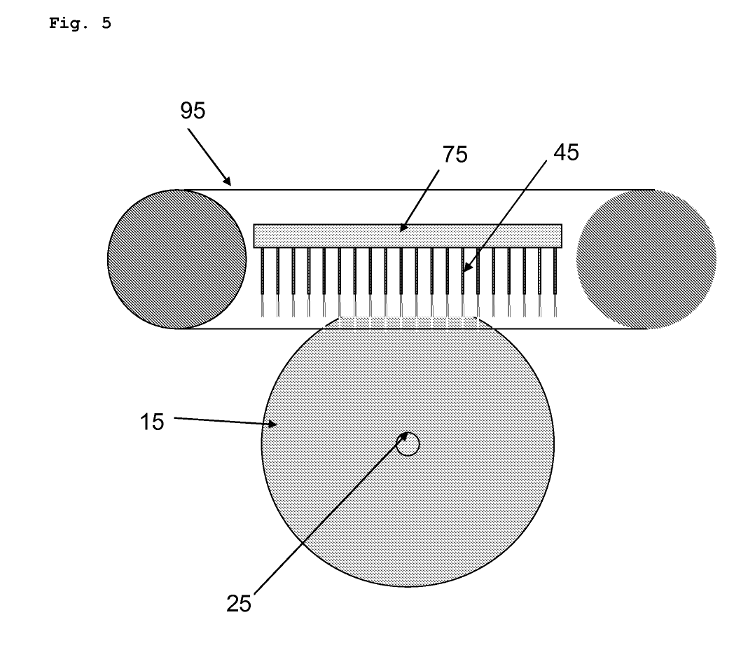

FIG. 5 shows the guiding of the band saw (or wire saw) which makes the horizontal cut along the workpiece.

The third unit carries out a horizontal cut along the axial direction of the rod 15.

The cutting width is in this case preferably adjusted so that it is somewhat less than the cutting depth of the first unit.

The third unit is in this case configured, for example, as a conventional band saw 95.

Since the cutting width of the band saw 95 is preferably adjusted so it is less than the cutting depth of the first unit, a channel is formed at the saw blade 45 during the sawing. Cooling liquid, which has been sprayed by the second unit, can flow past through this channel. This flow ensures optimal cooling and, above all, carries away the sawing slurry being formed.

Between the saw blades 45 in the direction of the middle of the rod 15, channels are formed through which the cooling liquid can flow and thereby carries away the sawing slurry being formed.

After the rod 15 has been cut through once lengthwise by the device described above, the thin rods are free and are now only held to one another by adhesion forces.

They can be picked up by means of a vacuum suction device and removed together from the rod 15.

Adhesion forces, however, also act between the thin rods and the rest of the workpiece. Nevertheless, these are drastically reduced since there is liquid exchange via the channels. A separating wedge, which would otherwise need to be used, is thus not necessary.

In order to prevent vibration of the thin rods, which are fastened only on one side during the sawing process, care should be taken that the distances between the units are small and do not permit resonances.

Instead of only a single shaft 31, a plurality of shafts may also be used in the first unit.

For the first unit, as an alternative to the multiplicity of saw blades 41 on a shaft 31, it is also possible to use a multiplicity of lasers which are respectively guided by means of a suitable liquid. Water is preferred as a liquid for guiding the laser. It is particularly preferable to use ultrapure water with the purity customary for the semiconductor industry.

An additional reduction of the cutting width to 40-80 μm, for example to 60 μm, is therefore possible, which is advantageous.

As an alternative, the cutting order of the first and third units may also be reversed since, for the liquid-guided laser cutting, flow away of the liquid required for the laser improves the cutting properties.

Furthermore, the provision of the cooling liquid in the second unit would then need to take place via the saw blade, since the channel otherwise necessary for this is absent.

The use of cooling liquid requires a liquid whose surface tension is very low in order to ensure wetting of the workpiece.

One possible way of minimizing the surface tension consists, as is known, in the addition of suitable detergents.

The choice of suitable substances is however very restricted in the case of silicon processing, especially if they adhere to the workpiece and may possibly cause contamination of it. In particular, surface-active additives such as wetting agents and surfactants are suitable, as are used in the semiconductor industry for example as an additive in polishing agents.

As an alternative, the rod is brought together with clean water to an elevated temperature, for example about 80° C., since the surface tension can be reduced with a higher temperature. This, however, is less preferred because of the increased outlay.

The third unit is preferably configured with a band saw 95.

It is, however, also possible to use a wire saw which is supplied with a sawing liquid (slurry) containing abrasive particles.

It is likewise possible to use a wire saw in which the abrasively acting particles are bound in the wire saw. The use of diamond wire is particularly preferred.

The use of a wire saw is particularly advantageous when liquid-guided laser cutting is employed in the first unit.

A rope saw may in principle also be envisaged, although it is less preferred because of the low sawing power.

Furthermore, the cut of the third unit may likewise be made with a saw blade 45 or with a plurality of saw blades on opposing shafts.

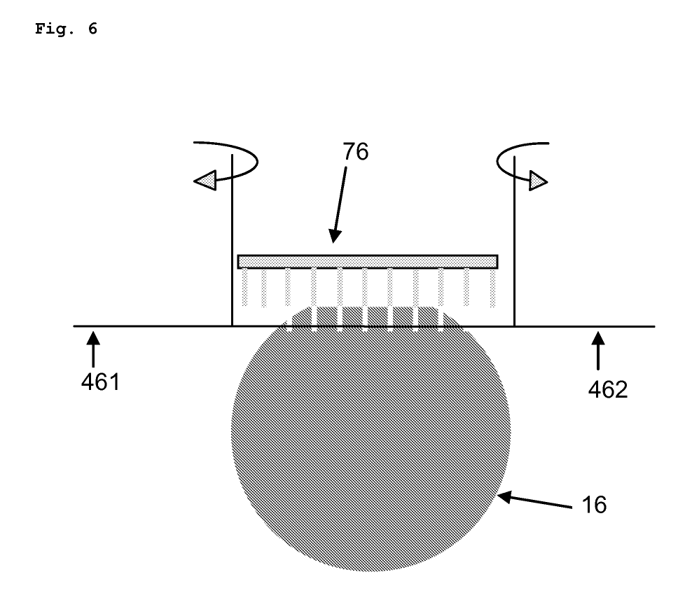

FIG. 6 shows the arrangement of two saw blades 461 and 462, which carry out the horizontal cut along the rod 16.

Between the saw blades 461 or 462, respectively, in the direction of the middle of the rod 16, channels are formed through which the cooling liquid coming from the tube 76 can flow and thereby carries away the sawing slurry being formed.

What is claimed is:

1. A method for producing thin silicon rods, comprising the following steps: a) providing a rod of silicon; b) sequentially cutting slabs having a particular thickness from the rod by way of a sawing device, wherein the rod is respectively rotated axially through 90° or 180° between two successive cuts so that of four successive cuts two of the four cuts respectively take place pairwise on radially opposite sides of the rod or wherein the cutting of the slabs takes place simultaneously together at radially opposite sides of the rod; and c) sawing the cut slabs into thin rods having a rectangular cross section.

2. The method as claimed in claim 1, wherein the sawing device is a band saw or a wire saw or cutting tools containing one or more shafts.

3. A method for producing thin silicon rods, comprising the steps: a) providing a rod of silicon; b) producing a multiplicity of vertical cuts over a total length of the rod by way of a first sawing device, wherein the cuts are mutually separated, wherein a spacing of the cuts and a cutting depth are formed according to a desired edge length of a thin rod with a rectangular cross section to be produced; c) producing a horizontal cut in a longitudinal direction of the rod by way of a second sawing device, in order to separate thin rods having a rectangular cross section from the rod; wherein steps b) and c) are sequentially carried out several times in succession and the rod is respectively rotated axially through 90° or 180° between two successive cuts according to c) so that of four successive cuts according to c) two of the four cuts respectively take place pairwise on radially opposite sides of the rod.

4. The method as claimed in claim 3, wherein the first sawing device comprises one or more shafts having saw blades.

5. The method as claimed in claim 3, wherein the first sawing device comprises a plurality of lasers guided in liquid.

6. The method as claimed in claim 3, wherein the second sawing device comprises a band saw or a wire saw or cutting tools containing one or more shafts.

7. The method as claimed in claim 4, wherein the second sawing device comprises a band saw or a wire saw or cutting tools containing one or more shafts.

8. The method as claimed in claim 5, wherein the second sawing device comprises a band saw or a wire saw or cutting tools containing one or more shafts.

9. A device for producing thin rods from a silicon rod by sawing, containing a first unit comprising a multiplicity of cutting tools and a cooling liquid for cooling the cutting tools, a second unit comprising nozzles for introducing additional cooling liquid into cutting kerfs of a workpiece to be processed, and a third unit comprising a band saw or a wire saw or cutting tools containing one or more shafts.

10. The device as claimed in claim 9, wherein the cooling system in the first unit comprises a slotted tube comprising slots which are entered by the cutting tools.

11. The device as claimed in claim 9, wherein the cutting tools of the first unit comprise saw blades which are fitted on one or more shafts.

12. The device as claimed in claim 10, wherein the cutting tools of the first unit comprise saw blades which are fitted on one or more shafts.

13. The device as claimed in claim 9, wherein the cutting tools of the first unit comprise a plurality of lasers guided in liquid.
